(19) United States
(12) Patent Application Publication
(10) Pub. No.: US 2011/0163539 A1
(43) Pub. Date: Jul. 7, 2011

(54) Connector for pipe-line

(76) Inventor: David Naor, Tel Aviv (IL)

(21) Appl. No.: 13/065,063

(22) Filed: Mar. 14, 2011

(30) Foreign Application Priority Data
Sep. 10, 2008 (IL) 194013

(51) Int. Cl. F16L 19/00

(52) U.S. Cl. 285/345

(57) ABSTRACT

A connector that enables fast connection and disconnection of a pipe to/from another pipe and accessories that are designed to be connected to a pipe, such as a bathroom or shower pipe. The connector comprises a hollow main body, a spring ring with flexible prongs that can be bent by applying force, and a compression ring that protrudes out from the main body and whose bottom part is shaped like an up-side-down truncated cone, enabling it to penetrate into the spring ring. When the compression ring is pressed, it penetrates into the main body. The conic part of the compression ring widens the hole in the compression ring by bending the prongs downward, enabling the pipe to penetrate into the flexible pronged ring. When application of pressure on the compression ring is ceased, the pipe can not be extracted from the connector. The connector can an integral part of an accessory or a pipe.

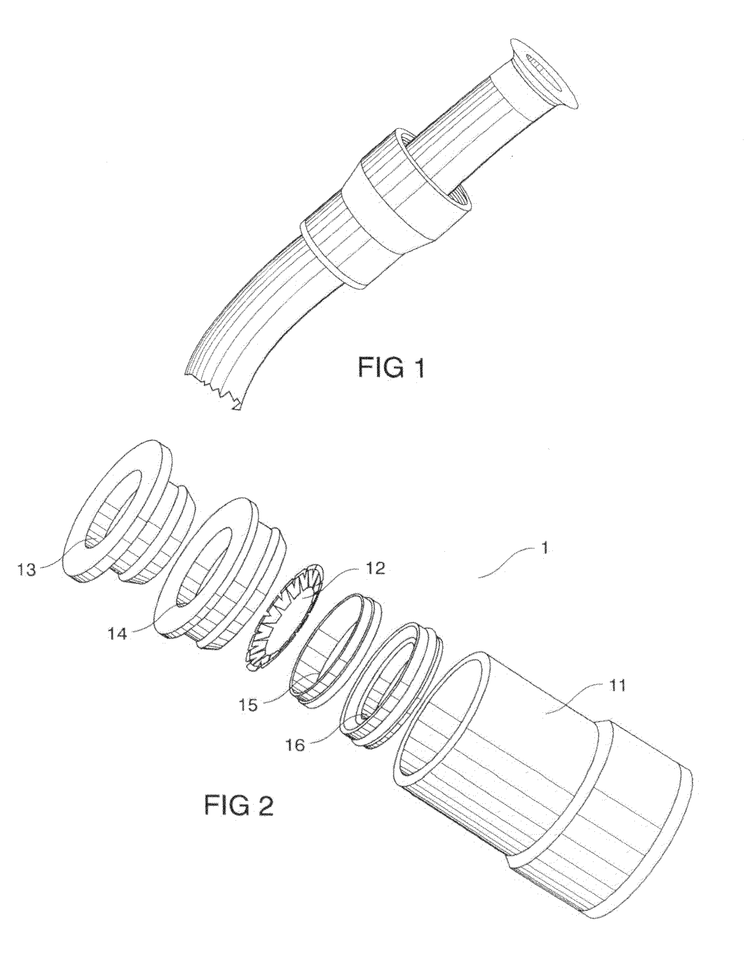

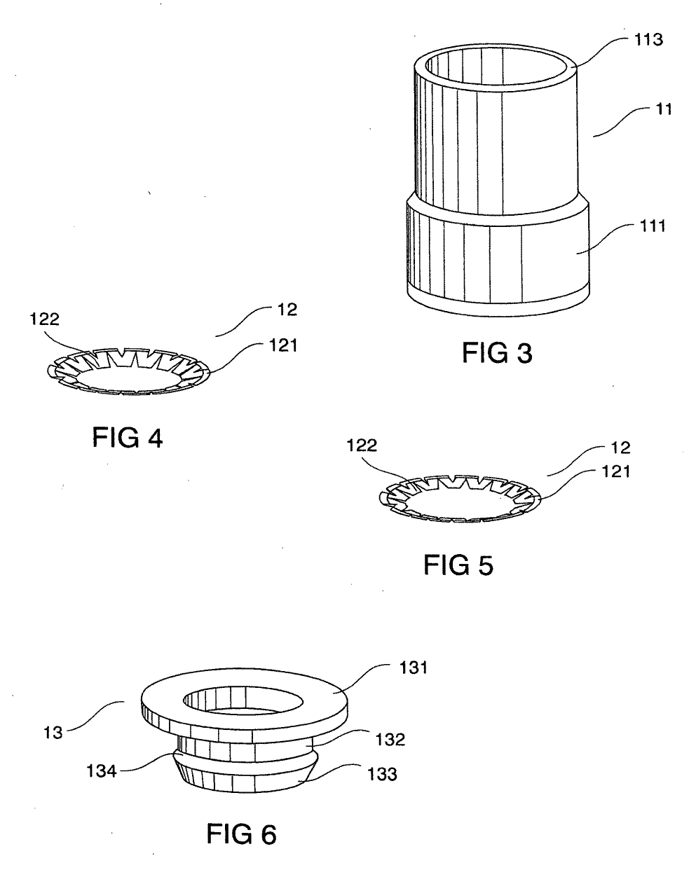

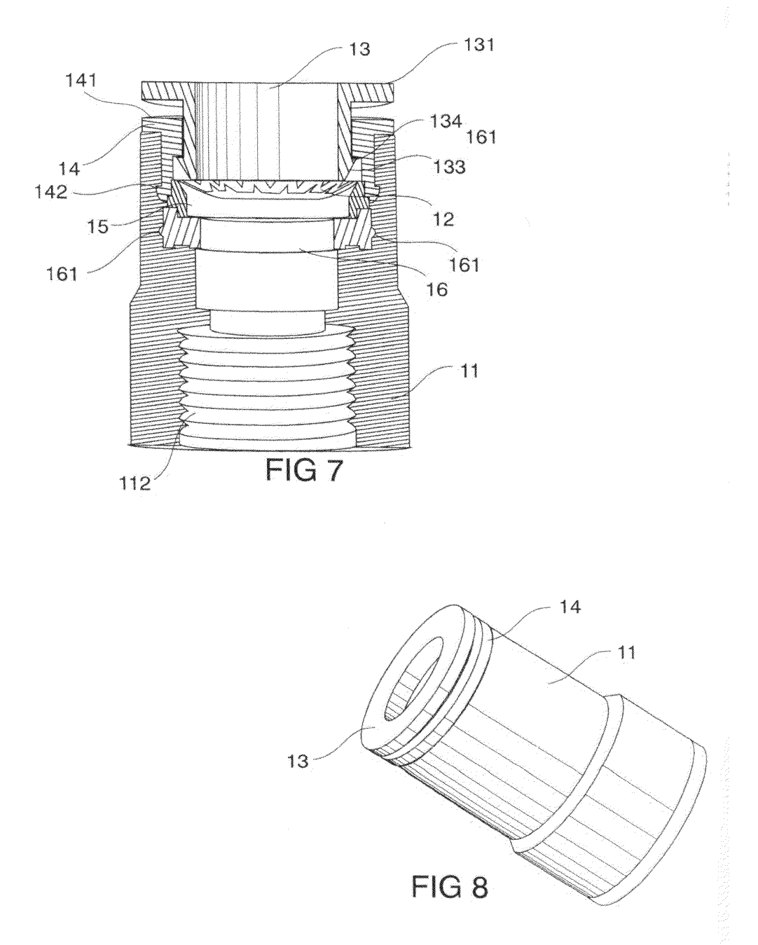

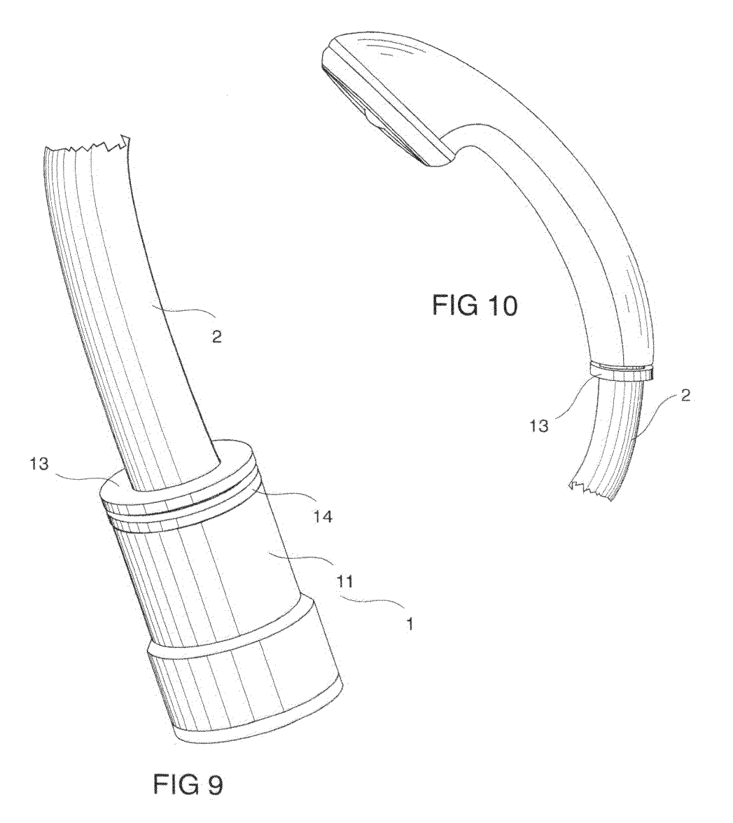

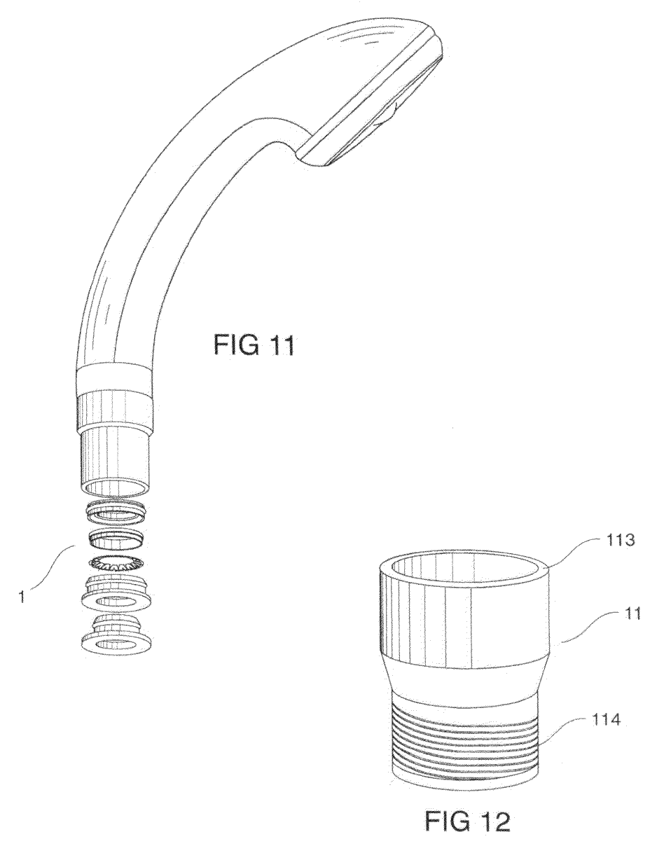

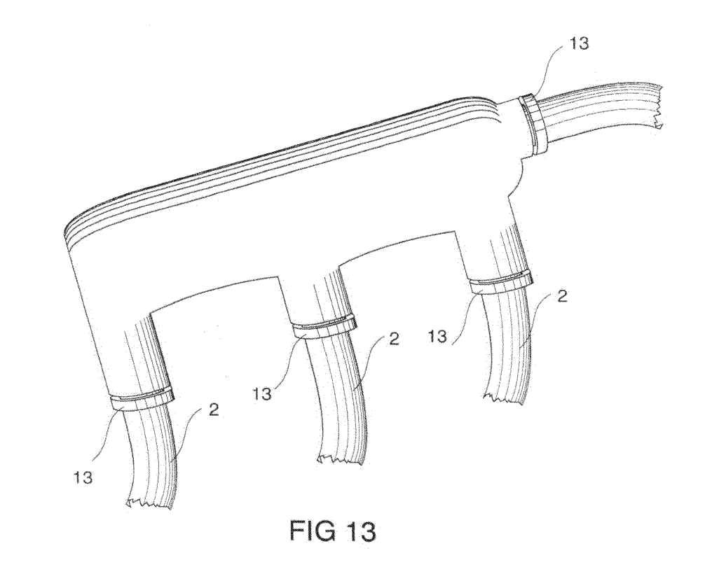

### TECHNICAL FIELD

The present invention refers to a connector for pipe systems.

### BACKGROUND ART

Many buildings have piping designed to carry liquids or gases. For example, residential homes, factories, offices, and other structures have piping designed to carry liquids, primarily water. In addition, many structures such as laboratories, hospitals, factories, and so on have piping designed to carry gases. To ensure the fluency of the explanation of the present invention we will refer here to exposed bathroom water piping, but only for the purpose of illustration and as an example. The present invention and patent application refer to and cover all types of piping, including all aforementioned types of piping.

In many cases, piping includes connectors between pipe segments and/or between a pipe segment and accessories, such as a bathroom wall water outlet pipe, a shower head, and so on. Pipes can be connected to a large variety of accessories, and to ensure fluency of the explanation of the present invention, we will refer to a bathroom wall water outlet pipe and to a shower head, but only for the purpose of illustration and as an example. The present invention and patent application refer to and cover all types of existing accessories as well as all types of existing screw threads.

The illustration of the invention in the present application refers to the pipe that connects the shower wall water outlet pipe to the shower head. This, however, does not detract from the fact that the invention relates to and covers all types of piping and accessories, as mentioned above.

The pipe that connects the water pipe that protrudes from the shower wall to the shower head includes standard and common connectors that are permanently attached to the ends of the pipe. The use of standard connectors involves several problems. Among other things, whenever a pipe needs replacing, the connectors must also be replaced since they are, as mentioned, permanently attached to the pipe. The present invention offers an efficient and suitable solution to the above problem as well as to other problems.

### THE INVENTION

The present invention refers to a connector (1) that enables fast and efficient connection and/or disconnection of one pipe to/from another pipe and/or to/from accessories that are designed to be connected to pipes. The invention also refers to a connector (1), as mentioned, that is manufactured in one piece with the accessory, for example, a handheld shower head as depicted in Drawings Nos. 10 and 11.

First, we will briefly describe the prior art, and then we will describe the connector (1), subject of the present invention. It is customary today to use pipes (2) made from and/or coated with flexible rubber (hereafter referred to as “the pipe”) in bathrooms, shower stalls, laboratories, and in many other places. The standard connection between the pipe (2) and the accessory (3) (such as a shower head or a bathroom wall water outlet pipe) is performed using a standard connector (4). The end of the connector (4) has a thread that matches a corresponding thread on the end of the accessory (3).

There is no need for a detailed explanation of the standard connector (4) since it is well known to any average professional in the field; nevertheless, it is depicted in general in Drawing No. 1.

The main objective of the connector (1), subject of the present invention, is to enable the user to rapidly connect and/or disconnect the pipe (2) to/from another pipe or accessory (3), without having to disassemble or unscrew the connector (1).

The connector (1), subject of the present invention, comprises several components as depicted, for instance, in Drawing No. 2. The connector (1) comprises three main components: a main body (11), a spring (12), and a compression ring (13).

The main body (11) is depicted in Drawing No. 3, and it is actually a hollow cylinder (like a pipe). The bottom (111) of the main body (11) has an internal thread (112, see Drawing No. 7).

The top of the main body has an upper rim (113). The cavity in the main body has an internal lip (114) which is actually a peripheral wall (as depicted, for example, in Drawing No. 7). The main body (11) can be made from a variety of materials, such as rigid plastic, metal, and so on. The thread on the main body (11) can be external, as depicted for instance in Drawing No. 12.

The spring (12) is depicted in Drawing No. 4, and its main objective is to grasp the pipe (2) when it is inserted into the connector (1) and to prevent it from being extracted. The spring (12) is shaped like a closed ring (121) with several V-shaped prongs (122). The prongs (122) protrude from the internal perimeter of the ring (121) towards the center of the ring. [Clarification: The spring (12) comprises, as mentioned, a ring (121) that creates a kind of circle. The circles formed by the spring (12) and the ring (121) are concentric.] One end of each prong (122) is connected to the ring (121) and the other end, which is the sharp end of the prong (122), points towards the center of the ring.

The spring (12) is made of a flexible material (such as, for instance, a flexible metal) so that when external pressure is applied on the prongs (122) they bend downwards (perpendicular to the ring). Drawing No. 4 depicts the spring (12) in rest position, that is, when no pressure or force is applied to the prongs (122) and they are pointing toward the center of the ring (121). Drawing No. 5 depicts the spring (12) whereby the prongs (122) are pointing down (as when an external force is applied to them).

The compression ring (13) is depicted in Drawing No. 6, and its main objective is to apply force on the prongs (122) of the spring (12) in order to release (disconnect) the pipe (2) from the connector (1), or to connect the pipe (2) to the connector (1). The compression ring (13) is shaped like a round disk with a hole in its center. The top part of the compression ring (13) is shaped like a relatively wide flange (131) (hereinafter referred to as the “top flange”). The middle part of the compression ring (13) is shaped like a straight cylinder (132), whereas the bottom part of the compression ring (13) is shaped like an up-side-down truncated cone (133) (hereinafter referred to as the “bottom cone”).

The principle manner of operation of the connector (1) and its aforementioned components: The spring (12) is inserted into the main body (11) so that the hole in the center of the ring (121) corresponds to the hollow of the main body (11). The spring (12) is inserted through the cavity in the upper end (113). Then, the compression ring (13) is inserted so that the bottom cone (133) is pushed into the hollow of the main body (11) and the top flange (131) of the compression ring (13) is resting on the upper rim (113) of the main body (11). The fact that the compression ring (13) has a relatively wide top flange (131) prevents it from being entirely inserted into the hollow of the main body (11). The spring (12) [or rather the prongs (122)] prevents the compression ring (13) from being inserted through the prongs (122). When, however, pressure is applied to the compression ring (13) towards the inside and center of the connector (1), the bottom cone (133) of the compression ring penetrates into the central hole in the ring (121) and causes the prongs (122) to bend downward (against their spring force) so that the hole in the center of the ring (121) widens (as depicted, for instance, in Drawing No. 5).

In this situation, when a pipe (2) is inserted into the connector (1) through the upper hole of the compression ring (13), the pipe (2) penetrates through the hole in the center of the ring (121) as well. When the pressure on the compression ring (13) is released (that is, the application of pressure is stopped), the spring force of the prongs (122) causes them to become firmly inserted into the rubber surrounding the pipe (2) in a way that prevents the pipe from being extracted. Since the prongs (122) are at an angle opposite the direction of pipe withdrawal, the force they apply on the pipe, which prevents it from being extracted, is greater. To extract the pipe (2) from the connector (1) (in other words: to release the pipe from the grasp of the prongs), the user must only (after first releasing the water pressure within the pipe) re-apply force and press the compression ring (13) so that the lower cone (133) is inserted into the hole in the center of the ring (121), causing the prongs (122) to bend downward, thus expanding the hole in the center of the ring (121) and releasing the pipe (2) from the grasp of the prongs (122).

To increase the efficiency of the connector (1), it can and should include the rest of the components, depicted for instance in Drawing No. 2, namely the upper pipe socket (14), and two rings (15) (16). The upper pipe socket (14) is, in fact, a tube-like disk with a wide top flange (141).

Assembly of the connector (1) and its components (when the connector is a stand-alone device): The following explanation refers to Drawing No. 7, which depicts the connector (1) in assembled state. (a) The ring (16) is inserted through the upper rim (113), into the hollow of the main body (11). The ring (16) is stopped by the internal lip (114) of the main body. The ring (16) has an external circumferential protrusion (161) whose function is to seal the space between the ring (16) and the main body (11). (b) The ring (15) is inserted into the ring (16). (c) The spring (12) is inserted into the main body (11) until it rests on the ring (15). (d) The upper pipe socket (14) is inserted into the hollow of the main body (11). The top flange (141) of the socket (14) is stopped by the top flange (113) of the main body (11).

The bottom part of the socket (14) has a circumferential protrusion (142) that rests on a corresponding recess in the interior of the main body (11), so that the socket (14) locks into the main body (11). Thus, the components of the connector (1) are joined snuggly together and do not separate. (e.) Finally, the compression ring (13) is inserted into the hollow of the main body (11) so that the circumferential flange (134) at the end of the bottom cone (133) locks into a corresponding recess in the socket (14), preventing dislocation of the compression ring (13) from the connector (1).

The connector (1) in Drawing No. 7 is depicted in assembled state and is ready for use. In this state, the compression ring (13) can neither be extracted from within the main body [thanks to the flange (134), which is locked into the upper socket (14)] nor can it be pressed further inward [thanks to the pressure the prongs (122) apply on it].

Nevertheless, the compression ring (14) can move slightly inwards when pressure is applied to it, slightly penetrating the ring (121) of the spring (12) so that the prongs (122) are bent downwards. When the pressure on the compression ring (13) is stopped, the spring pressure of the prongs (122) pushes the compression ring (13) slightly outward, and back to its neutral position.

Assembly of the connector (1) and its components (when the connector is part of an accessory): In this case, the bottom part of the accessory constitutes the main body (11) of the connector (1) and assembly is carried out as described above.

Use of the connector (1) (when not part of an accessory): The connector (1) is connected to any pipe or accessory (3) by screwing the connector's (1) internal thread (112), which is located within the main body, onto the external thread of the relevant pipe or accessory (3).

Then, when the user wishes to connect a pipe (2) to the accessory (3), he or she must only press lightly on the compression ring (13), insert the pipe (2) into the central hollow of the connector (1) [until it passes through the ring (121), which makes up the spring (12)], and release pressure on the compression ring (13). As a result, the prongs (122) will grasp the rubber that surrounds the pipe (2) and prevent it from being extracted, and vice versa. Drawing No. 8 presents the connector (1) in perspective and Drawing No. 9 depicts the connector (1) with a pipe (2) connected to it.

Use of the connector (1) (when part of an accessory): In this case, the connector (1) is an integral part of the accessory. When the user wishes to connect a pipe (2) to the accessory (3), he or she must only press lightly on the compression ring (13), insert the pipe (2) into the hollow of the connector (1) [until it passes through the ring (121), which makes up the spring (12)], and release pressure on the compression ring (13). As a result, the prongs (122) will grasp the rubber that surrounds the pipe (2) and prevent it from being extracted, and vice versa. See for example Drawings Nos. 10 and 11.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

Drawing No. 1 depicts the existing, standard connector.

Drawing No. 2 depicts the components of the connector (1).

Drawing No. 3 depicts the main body (11).

Drawing No. 4 depicts the spring (12) in rest position.

Drawing No. 5 depicts the spring (12) under pressure.

Drawing No. 6 depicts the compression ring (13).

Drawing No. 7 depicts a cross-section of the assembled connector (1).

Drawing No. 8 depicts the connector (1) in perspective.

Drawing No. 9 depicts the connector (1) with a pipe connected to it.

Drawing No. 10 depicts an accessory (shower head) whereby the connector (1)

constitutes an integral part there of and is connected to a pipe (2).

Drawing No. 11 depicts an accessory (shower head) and the components of the connector (1), which constitutes an integral part thereof and which is connected to a pipe (2).

Drawing No. 12 depicts the main body (11) with its external thread (114).

Drawing No. 13 depicts a manifold based on the use of several connectors (1).

What is claimed is:

1. A connector that enables fast connection and disconnection of a pipe to/from another pipe and to/from accessories that are designed to be connected to a pipe. The connector comprises a hollow main body, a spring ring with flexible prongs, and a compression ring.

2. The connector mentioned in claim No. 1 whereby the said main body is designed as a hollow cylinder (like a pipe) and its lower end has an internal or external thread; the said spring ring is designed to grasp a pipe inserted into the said connector and prevent it from being extracted; the said spring ring has the shape of a closed ring with several prongs that protrude from the inner circumference of the said ring towards the center of the ring; the said spring ring is made of a flexible material so that when external pressure is applied to the said prongs they bend downwards and when no pressure is applied they point towards the center of the said spring ring; whereby the said compression ring is designed to apply force on the said prongs of the said spring ring in order to release (disconnect) or connect the pipe from/to the said connector; the said compression ring is shaped like a round disk with a hole in its center; the upper part of the said compression ring has a relatively wide flat flange; the lower part of the said compression ring is shaped like an up-side-down truncated cone.

3. The connector mentioned in claim No. 1 whereby it is integrally connected to a pipe or an accessory.

4. The connector mentioned in claim No. 2 whereby it is integrally connected to a pipe or an accessory
